(19) United States
(12) Patent Application Publication
(10) Pub. No.: US 2025/0334159 A1
(43) Pub. Date: Oct. 30, 2025

(54) BRAKE PAD WITH OPTIMISED COOLING

(71) Applicant: Beringer Aero, Tallard (FR)

(72) Inventor: Gilbert Beringer, Fouillouse (FR)

(73) Assignee: Beringer Aero, Tallard (FR)

(21) Appl. No.: 18/729,373

(22) PCT Filed: Oct. 24, 2022
(86) PCT No.: PCT/FR2022/052012

§ 371 Date: Dec. 12, 2024

(30) Foreign Application Priority Data
Jan. 31, 2022 (FR) FR2200828

(51) Int. Cl. F16D 65/847; F16D 55/00; F16D 65/00; F16D 65/095; F16D 65/78

(52) U.S. Cl. CPC F16D 65/847; F16D 65/095; F16D 2055/002; F16D 65/0075; F16D 2065/785; F16D 2065/789; F16D 2200/0021; F16D 2200/0039

(57) ABSTRACT

The invention concerns a brake pad (10) for a disc brake caliper, the pad (10) comprising a support plate (11). According to the invention, the support plate (11) has cooling fins (17), thus creating a convection zone (16).

### TECHNICAL FIELD

The invention relates to the technical field of disc brakes, particularly to the pads equipping such brakes.

### PRIOR ART

In the field of disc brakes, braking effort is directly related to parameters such as:
The material of the pads;
The material of the disc;
The surface area of the friction zone of the pads on the disc;
The clamping force of the pads on the disc.

Braking performance is related, among other things, to:
The obtainable braking effort;
Kinetic parameters, such as the rotational speed of the disc, the kinetic energy of the vehicle equipped with the brake, and especially the kinetic energy to be dissipated during each braking event;
The frequency of brake use over time;
The thermal parameters of the brake, particularly its ability to withstand the heat generated during the conversion of kinetic energy into thermal energy or to dissipate this heat.

Advances in brake pads have enabled them to generate greater braking efforts. However, this increase results in more heat generated by braking. During intensive use, such as in motorsports like motorcycle racing, or in aviation on aircraft landing gear, especially light aircraft, the pads and brake discs can reach very high temperatures, around 800° C. This heat is transmitted to the caliper and its components, which can degrade at such temperatures. Such temperature rises are not present in the cycling field, for example.

In particular, in cycling, braking is less intense and spread over a longer duration, whereas in aviation, braking is much more significant and lasts only 10 to 15 seconds. The brake disc heats up to a red-hot state. Then, the heat from the disc dissipates, heating the caliper, and caliper malfunctions occur in the minutes following landing braking.

It is known to place a thermal insulator between the pad and the components generating the clamping force on it. However, this insulator, by nature, prevents the evacuation of the heat generated by braking, thereby limiting the pad's ability to cool. These solutions can, therefore, be improved.

Documents DE102007025113B4, US20140151168A1, US20170067524A1, DE202014101924U1, and U.S. Pat. No. 6,206,151B1 disclose pads for disc brakes that include solutions aimed at facilitating the cooling of these pads.

### SUMMARY OF THE INVENTION

One of the objectives of the invention is to overcome the disadvantages of the prior art by proposing high-performance brake pads, whose high temperature during intensive use does not degrade the components of the caliper.

To this end, a brake pad for a disc brake caliper has been developed, comprising a support plate.

According to the invention, the support plate features cooling fins, thus creating a convection zone. The cooling fins are simple to manufacture on the support plate and significantly increase the convection exchange surface between the pad and the ambient air surrounding the pad.

In this way, the convection zone allows heat to be evacuated by convection, enabling intensive use of the pad and the dissipation of heat generated during braking. There is no degradation of other components of the caliper.

The fins being contained within the plane of the plate, the thickness of the pad is not increased, and the overall size is not penalized.

The support plate features a rear face with a contact zone, which is thermally insulated from other caliper components by a thermal insulator. Thus, the mechanical components generating the contact on the pads are protected from heat.

To increase the surface area of the convection zone, the thermal insulator only covers part of the rear face, leaving an uncovered rear zone, which is also part of the convection zone.

Similarly, the support plate features a front face receiving a lining with a friction zone, and the lining only covers part of the front face, leaving an uncovered front zone, which is also part of the convection zone.

To evacuate enough heat, the uncovered rear zone represents at least 10% of the rear face area, preferably at least 20%.

Preferably, the convection zone is located on either side of the contact zone. Thus, heat is properly drained from the contact zone, which is hot due to being covered by the insulator, towards the different portions of the uncovered zone.

To have sufficient thermal and mechanical resistance characteristics, the support plate is made of low-alloy steel, comprising less than 0.3% by mass of carbon, preferably less than 0.2%, and vanadium in an amount between 0.2 and 0.3% by mass, with the rest being preferably iron with reasonably foreseeable impurities. The plate is, for example, made of 15CDV6 steel. The presence of vanadium notably improves the hot strength of the plate.

To achieve a compact and lightweight assembly, while sufficiently protecting the caliper components, the insulator is in the form of a sheet, preferably held by a clip snapped onto the support plate.

To present optimal thermal performance, even when the insulator is in the form of a sheet, the insulator comprises mica.

To further improve thermal performance, the clip is made of austenitic steel, which is less heat-conductive than other alternative grades.

The invention also concerns a disc brake caliper incorporating pads with the above characteristics. Such a caliper provides better braking performance than prior art devices since the thermal resistance constraint of its components has been removed. For example, a greater clamping force can be applied.

### BRIEF DESCRIPTION OF THE DRAWINGS

FIG. 1 is a rear perspective view of a support plate of a brake pad according to the invention.

FIG. 2 is a rear perspective view of another brake pad support plate according to the invention.

FIG. 3 is a rear perspective view of such a pad.

FIG. 4 is a front view of the support plate.

FIG. 5 is a partial front view of a caliper according to the invention.

FIG. 6 is a perspective view of such a caliper.

### DETAILED DESCRIPTION OF THE INVENTION

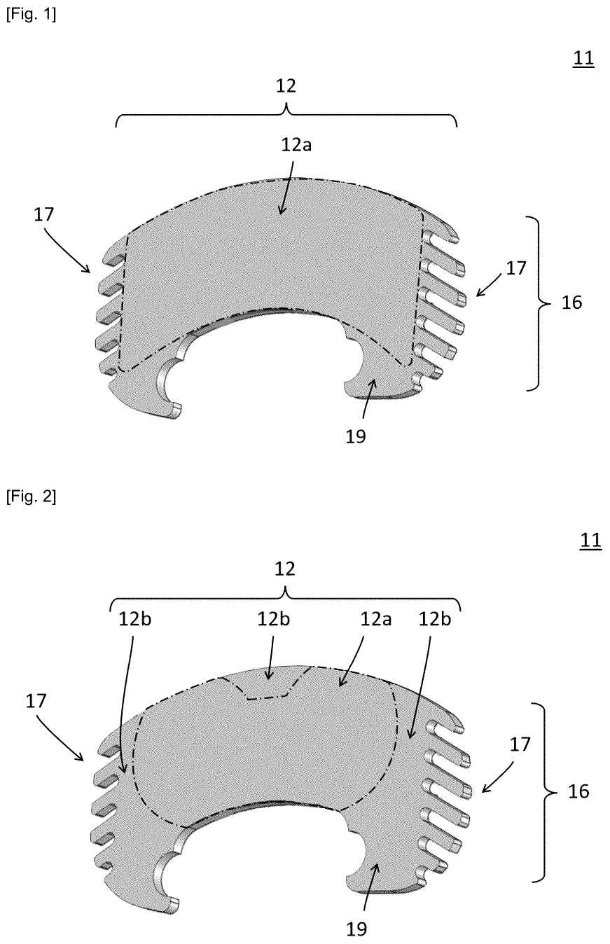

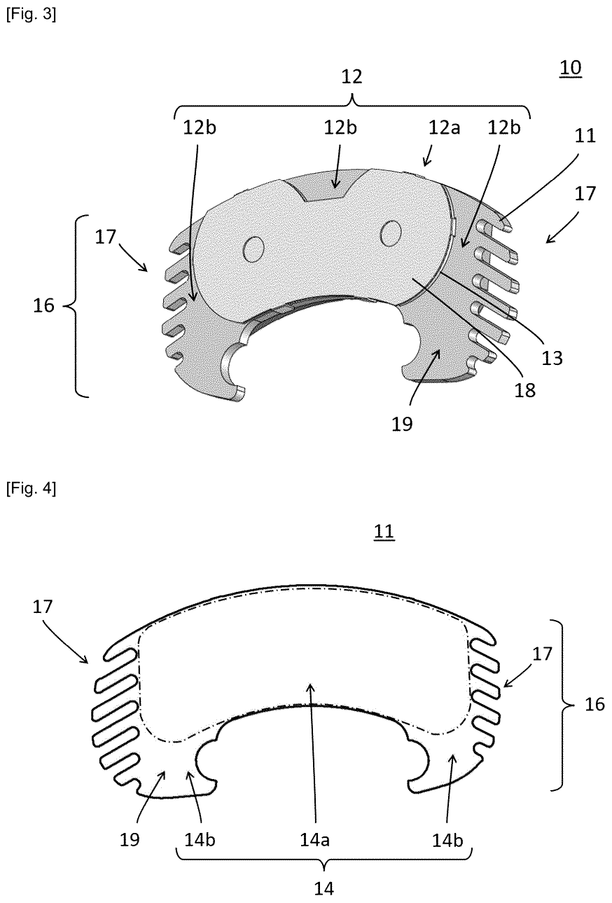

With reference to FIGS. 1 to 6, the invention essentially consists of designing, for a brake pad (10), an arrangement of the thermal insulator (13) such that at least one uncovered rear zone (12b) is visible, meaning it is not covered by the thermal insulator (13).

It is recalled that this insulator (13) is necessary to protect other components of the caliper (20) from heat, but limiting its presence to the strictly necessary, that is, to the contact zone (12a) only (the interface between the rear face (12) and the parts applying the clamping force) allows creating at least one convection zone (16) for evacuating the heat generated during braking.

The thermal insulator (13) advantageously comprises mica, providing an effective insulator even with a small thickness. The mica sheet is held in position on the plate (11) by a clip (18), which is snapped onto the plate (11).

In practice, it is advantageous to design a support plate (11) that is oversized, meaning it is wider than required by the dimensions of the lining (15) and the contact zone (12a).

FIGS. 1, 2, and 4 show the outlines corresponding to the dimensions of the lining (15) on the front face (14) and the contact zone (12a) on the rear face (12). A sufficient size for the support plate (11) is the smallest geometry that encompasses these outlines, as illustrated in FIG. 1.

With reference to FIGS. 2 and 4, the plate (11) is oversized so that:
On the rear face (12), significant portions extend beyond the insulator (13), forming large uncovered rear zones (12b);
On the front face (14), significant portions extend beyond the lining (15), forming large uncovered front zones (14b).

This significantly increases the surface area of the convection zone (16), which linearly increases the energy that can be dissipated by this zone (16).

We are not specifically concerned with the functional surfaces for connecting the plate (11) to the caliper (20), which are not covered by the insulator (13) or the lining (14), as the invention mainly lies in the addition of fins (17) and preferably the additional addition of uncovered rear zones (12b) and uncovered front zones (14b).

There is generally space available on the sides of a pad (10) for such oversizing. Of course, increasing the thickness of the plate (11) is not considered since its edge, although participating in thermal exchanges by convection, would not yield significant gains by increasing the thickness. Furthermore, space in this direction is limited.

The surface area of the uncovered rear zone (12b) represents at least 10% of the rear face area (12), preferably at least 20%. In the illustrated mode, the surface area of the uncovered rear zone (12b) represents about 40% of the rear face area (12).

If the lining (15) does not cover the entire front face (14), the surface area of the uncovered front zone (14b) represents at least 10% of the front face area (14), preferably at least 20%. In the illustrated mode, the surface area of the uncovered front zone (14b) represents about 30% of the front face area (14).

These ratios ensure that the convection zone (16) is large enough to evacuate the heat generated during braking.

To evacuate heat more easily, it is advantageous not to place the convection zone (16) on only one side of the plate (11), but rather on both sides. In the illustrated embodiments, the convection zone (16) is positioned on the right and left. Depending on the available space, it is also possible to extend the convection zone (16) upwards and downwards.

The pad (10) thus designed can withstand very high braking efforts, generating a large amount of heat, and then dissipate this heat quickly. It is therefore important that the material constituting it is suitable to withstand such thermal constraints, which are deleterious due to:
The temperature values reached (sometimes exceeding 700° C.), and
The frequency of braking (typically 5 to 10 braking events per minute during motorsports use).

A material suitable for meeting such thermal and mechanical constraints is the 15CDV6 steel alloy.

Tests were conducted by the Applicant comparing 15CDV6 steel with a steel known as “Imex700” or S 690 QL according to the European standard EN 10025-6: March 2005, initially used to make the plate (11) and the 15CDV6.

The tests consisted of bending tests on Imex700 specimens and 15CDV6 specimens. The specimens have identical dimensions, except for the thickness of 4 mm for Imex700 and 3 mm for 15CDV6. During the bending test, the specimen is held horizontally and fixedly at one end by a clamp, and a weight is suspended from the other end. A section of the specimen near the clamp is reduced to ensure the specimen bends at that point. The distance between the free end of the specimen and the reduced section is 150 mm.

The specimen is first tested at 21° C. by suspending weights until plastic deformation of the reduced section occurs.

Then, a new specimen is tested by suspending weights and heating the reduced section to 600° C. The specimen is then allowed to cool in air, and its straightness is checked to determine if the elastic limit has been exceeded. Tests are repeated with different weights until the limit between elastic and plastic deformation is found.

The test results are compiled in the table below, noting that given the difference in thickness between the specimens, the induced stress was normalized to account for this difference.

TABLE 1

| | | Bending | Induced | | | |
|---|---|---|---|---|---|---|
| | Thickness | Weight | Stress | | | |
| Steel | (mm) | (kg) | (Mpa) | Bent | Heated | |
| 15CDV6 | 3 | 14.06 | 1970 | Yes | 21° | C. |
| 15CDV6 | 3 | 7.02 | 984 | Yes | 600° | C. |
| 15CDV6 | 3 | 5.6 | 785 | No | 600° | C. |
| Imex700 | 4 | 17 | 1340 | Yes | 21° | C. |
| Imex700 | 4 | 8.62 | 680 | Yes | 600° | C. |
| Imex700 | 4 | 5.82 | 459 | No | 600° | C. |

It can be seen that 15CDV6 withstands an induced stress of 785 Mpa when heated to 600° C., while Imex 700 withstands only 459 Mpa. Thus, 15CDV6 is 70% more resistant than Imex700.

Since the pad (10) is designed to withstand very high braking efforts, it is necessary to reinforce the zones ensuring its kinematic connection with the caliper (20). In this case, a kinematic connection of the slider type is obtained by hemispherical ears present on the plate (11) cooperating with sleeves (21) of the caliper (20). However, the direction of significant braking is always the same, that of the vehicle's advance: it is, therefore, not judicious to reinforce the connection on both sides of the pad (10).

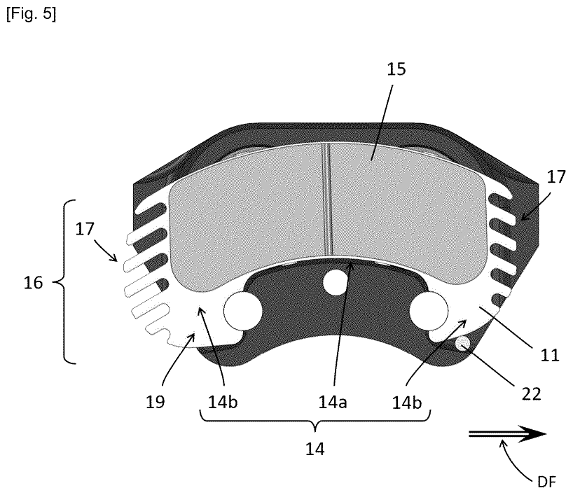

The pad (10) is, in the illustrated mode, asymmetrical: only one reinforced portion (19) is present, arranged to retain the pad (10) in the braking direction (DF) illustrated in FIG. 5.

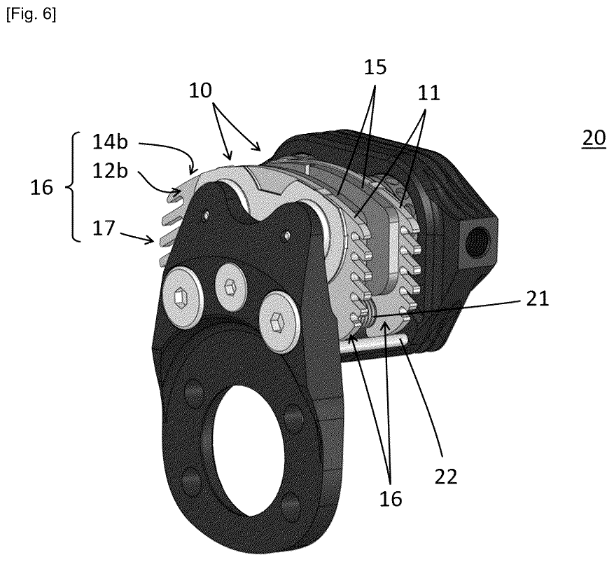

Since the pads (10) are asymmetrical, they must not be mounted upside down on the caliper (20). Anti-mistake means are, therefore, present. With reference to FIG. 6, it could be, for example, a stop (22) mounted on the caliper (20), and the reinforced portion (19) is configured to stop against the stop (22). Therefore, it is not possible to mount the pad (10) upside down.

The pads (10) according to the invention exhibit excellent thermal performance, maintaining the caliper (20) temperature at only 60° C. while braking efforts have led the disc (40) to a temperature of around 800° C. (the metal of the disc (40) is red-hot).

Nevertheless, the pads (10) have very limited bulk, especially in terms of thickness. Moreover, a too large thickness tends to tip the pads during braking. A thin pad also helps limit uneven wear.

Additionally, the pad (10) and the caliper (20) can be shaped differently from the given examples without departing from the scope of the invention, defined by the claims.

Furthermore, the technical characteristics of the different embodiments and variants mentioned above can be combined, in whole or in part. Thus, the pad (10) and the caliper (20) can be adapted in terms of cost, functionality, and performance.

1. Brake pad (10) for a disc brake caliper (20), the pad (10) comprising a support plate (11), characterized in that the support plate (11) has cooling fins (17), thus creating a convection zone (16).

2. Brake pad (10) according to claim 1, characterized in that the support plate (11) has a rear face (12) with a contact zone (12a), the contact zone (12a) is thermally insulated from other caliper components (20) by a thermal insulator (13), and the thermal insulator (13) covers only part of the rear face (12), leaving an uncovered rear zone (12b), which is also part of the convection zone (16).

3. Brake pad (10) according to any of the preceding claims, characterized in that the support plate (11) has a front face (14) receiving a lining (15) with a friction zone, and the lining (15) covers only part of the front face (14), leaving an uncovered front zone (14b), which is also part of the convection zone (16).

4. Brake pad (10) according to claim 2, characterized in that the uncovered rear zone (12b) represents at least 10% of the rear face area (12), preferably at least 20%.

5. Brake pad (10) according to any of the preceding claims, characterized in that the convection zone (16) is located on either side of the pad (10).

6. Brake pad (10) according to any of the preceding claims, characterized in that the support plate (11) is made of low-alloy steel, comprising less than 0.3% by mass of carbon, preferably less than 0.2%, and vanadium in an amount between 0.2 and 0.3% by mass.

7. Brake pad (10) according to claim 1, characterized in that the support plate (11) has a rear face (12) with a contact zone (12a), the contact zone (12a) is thermally insulated from other caliper components (20) by a thermal insulator (13) in the form of a sheet.

8. Brake pad (10) according to claim 7, characterized in that the insulator (13) is held by a clip (18) snapped onto the support plate (11).

9. Brake pad (10) according to claim 8, characterized in that the clip (18) is made of austenitic steel.

10. Brake pad (10) according to claim 2 or claim 7, characterized in that the insulator (13) comprises mica.

11. Caliper (20) for a disc brake equipped with a break pad (10) according to any of the preceding claims.
